(19) United States
(12) Patent Application Publication
(10) Pub. No.: US 2006/0153101 A1
(43) Pub. Date: Jul. 13, 2006

(54) Data transmission method in communication system, controller and communication terminal

(76) Inventor: Tommi Raisanen, Espoo (FO)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/065,714

(22) Filed: Feb. 25, 2005

(30) Foreign Application Priority Data
Jan. 10, 2005 (FI) 20055013

(51) Int. Cl. H04L 12/16

(52) U.S. Cl. 370/260

(57) ABSTRACT

The invention is related to a controller of a communication system, comprising: storing means for storing information on a data conveyance group; uplink and downlink connection means for data conveyance; first activating means for activating the downlink connection means to data conveyance group members; identifying means for identifying a data conveyance group member having data to be conveyed; second activating means for activating the uplink connection means for data conveyance; first deactivating means for deactivating the uplink connection means; and second deactivating means for deactivating the downlink connection means.

### FIELD

The invention relates to a data transmission method in a communication system when the communication system comprises at least one controller. The invention also relates to a controller of a communication system and a communication terminal.

### BACKGROUND

Circumstances exist wherein a need for data conveyance between predetermined service subscribers arises. Such circumstances may for instance be data conveyance between security guards, department store personnel or organisers of events or functions.

In global system for mobile communications/enhanced data rates for global evolution (GSM/EDGE) communication systems, a possibility is provided to establish group calls. It is called a voice group call service (VGCS). A problem with such a VGCS service is, however, that it is carried out controlled by a mobile services switching centre (MSC). Since VGCS is quite a new service, operators may have built up their networks with mobile services switching centres that do not necessarily support VGCS. Therefore, a possibility to offer data conveyance between predetermined service subscribers without MSC is needed.

Additionally, the prior art VGCS system spends a great number of A-interface circuits because one A-interface circuit is allocated for each VGCS channel belonging to the same VGCS call.

### BRIEF DESCRIPTION OF THE INVENTION

According to an aspect of the invention, there is provided a data transmission method in a communication system, the communication system comprising at least one controller, the method comprising: determining a data conveyance group into a database used by the controller; and conveying data between group members by using a group circuit arrangement including a loop circuit for transferring data from a transmitting group member and branches to receiving members.

According to another aspect of the invention, there is provided a data transmission method in a communication system, the communication system comprising at least one controller, the method comprising: determining a data conveyance group into a database used by the controller; activating downlink connections to data conveyance group members; identifying a data conveyance group member having data to be conveyed and activating an uplink connection for data conveyance; conveying the data of the data conveyance group member to other members by using the uplink and downlink connections; and deactivating the uplink connection after data conveyance; deactivating the downlink connections.

According to another aspect of the invention, there is provided a data transmission method in a communication system, the communication system comprising at least one controller, the method comprising: specifying a data conveyance group into a database used by the controller; detecting a group member having data to be transmitted and establishing connections for conveying the data; conveying the data of the group member to other members of the data conveyance group by using the connections; and disbanding the connections after data conveyance.

According to another aspect of the invention, there is provided a controller of a communication system, comprising: means for storing information on a data conveyance group; and means for conveying data between group members by using a group circuit arrangement including a loop circuit for transferring data from a transmitting group member and branches to receiving members.

According to another aspect of the invention, there is provided a controller of a communication system, comprising: storing means for storing information on a data conveyance group; uplink and downlink connection means for data conveyance; first activating means for activating the downlink connection means to data conveyance group members; identifying means for identifying a data conveyance group member having data to be conveyed; second activating means for activating the uplink connection means for data conveyance; first deactivating means for deactivating the uplink connection means; and second deactivating means for deactivating the downlink connection means.

According to another aspect of the invention, there is provided a controller of a communication system, comprising: means for storing information on a data conveyance group; connection means for conveying data; means for detecting a data conveyance group member having data to be transmitted; means for activating the connection means; and means for disbanding the connection means.

According to another aspect of the invention, there is provided a controller of a communication system, configured to: store information on a data conveyance group; activate downlink connection means to data conveyance group members; identify a group member having data to be conveyed; activate uplink connection means; convey the data of the group member to other members by using the uplink and downlink connection means; and deactivate the uplink connection means and the downlink connection means.

According to another aspect of the invention, there is provided a communication terminal, comprising: means for generating at least one transmission for controlling group data conveyance, the transmission being transmitted to a controller of a communication system for processing.

According to another aspect of the invention, there is provided a communication terminal, configured to: generate at least one transmission for controlling group data conveyance, the transmission being conveyed to a controller of a communication system for processing.

The invention provides several advantages.

In an embodiment of the invention, operators are able to offer group data conveyance to their clients without a need to update a mobile services switching centre of their network.

Another advantage is that data, speech for instance, has to be encoded and decoded only in the user terminal. When coding is carried out for A-interface transmissions, no other encoding and decoding steps are needed in a network element when data is transferred between cells controlled by the same base station controller (BSC).

Yet another advantage is an opportunity to save A-interface circuitry.

### LIST OF DRAWINGS

In the following, the invention will be described in greater detail with reference to the embodiments and the accompanying drawings, in which

FIG. 1 shows an example of a communication system;

FIG. 2 is a flow chart;

FIG. 3 illustrates an example of a logical structure of a base station controller;

FIG. 4 shows an example of a loop circuit;

FIG. 5 illustrates an example of a user terminal.

### DESCRIPTION OF EMBODIMENTS

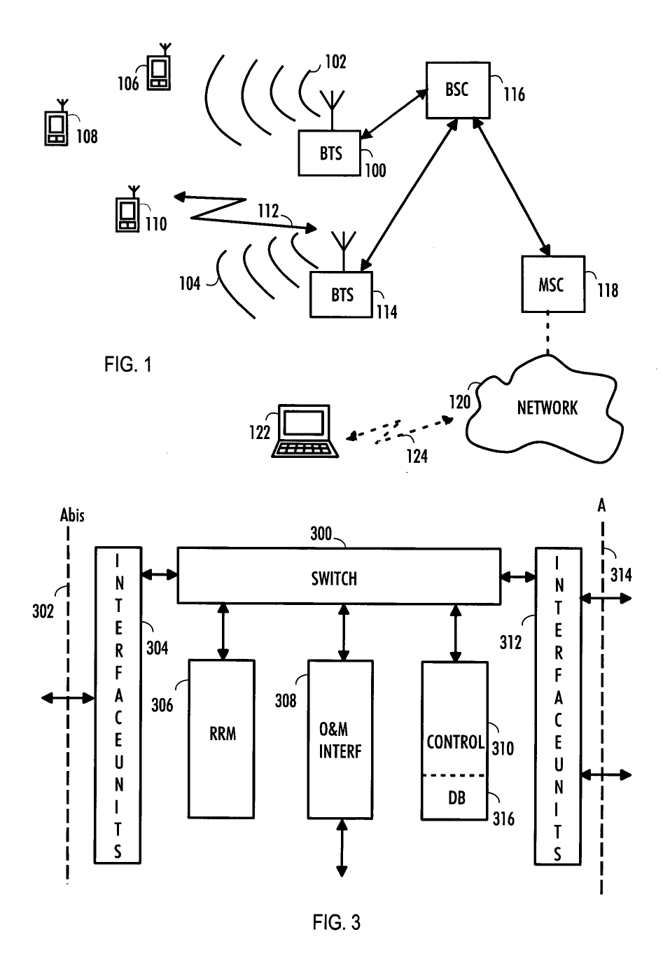

With reference to FIG. 1, we examine an example of a communication system whereto embodiments of the invention can be applied. The present invention can be applied to various communication systems. An example of such a communication system is GSM (Global System for Mobile Communications). The embodiments are not, however, restricted to the systems given as examples, but a person skilled in the art may apply the solution to other systems provided with the necessary properties.

It is clear to a person skilled in the art that the method according to the invention can be applied to systems utilizing different modulation methods or air interface standards.

FIG. 1 is a simplified illustration of an example of a communication system to which the solution according to the invention is applicable. This is a part of a cellular radio system, which comprises base station 100 having a downlink radio channel (illustrated by wave front 102) that is listened by user terminals 106, 108. The user terminals may be fixed, vehicle-mounted or portable. The base station includes transceivers, for instance. From the transceivers of the base station there is a connection to an antenna unit, which establishes the radio connection between the base station and the user terminal. In conveying group data, such as a group call, the base station broadcasts on a radio channel allocated for the group call.

In FIG. 1, another cell of the cellular radio system is also depicted including user terminal 110 and base station 114 to which the user terminal has radio link connection 112. Base station 114 can also broadcast data to other user terminals in the cell. This is illustrated as wave front 104.

The base stations are further connected to base station controller (BSC) 116, which transmits the connections of the terminals to other parts of the network. The base station controller is further connected to a core network (CN). Depending on the system, the counterpart on the CN side can be a mobile services switching centre (MSC) 118, a media gateway (MGW) or a serving GPRS (general packet radio service) support node (SGSN).

The cellular radio system can also communicate with other networks 120, such as a public switched telephone network or the Internet. Therefore user 122 may also have data transmissions with users 106, 108, 110 of the cellular network in question using for instance radio link 124.

The situation illustrated in FIG. 1 is that user terminal 110 transmits data to user terminals 106, 108.

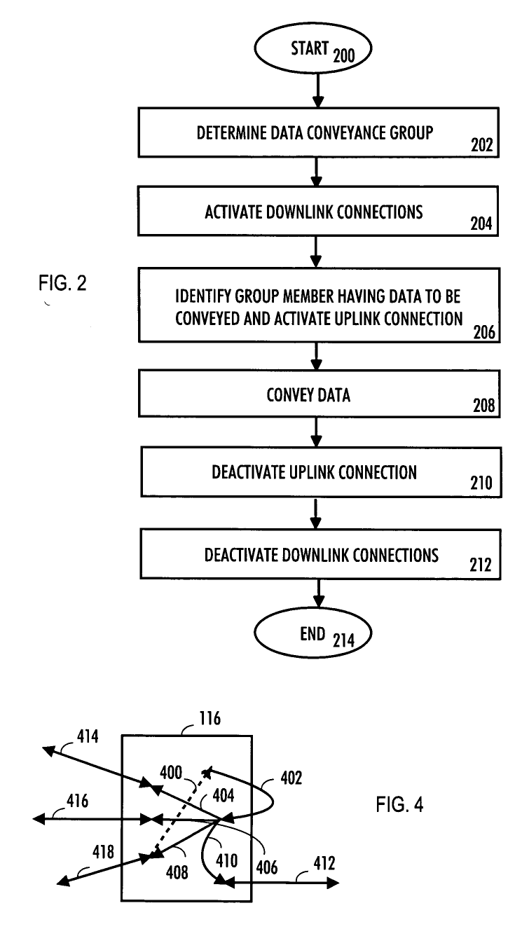

FIG. 2 depicts an embodiment of the data transmission method. The basic idea underlying behind the method is to utilize a radio network database of a base station controller (BSC) to determine cells belonging to a data transmission group area.

Data to be transmitted is typically speech but can be any kind of data. In one embodiment, data transmission is carried out in real-time and in a half-duplex mode. The transmission may be carried out by connecting the channel of the transmitting user by a loop circuit as an uplink input to the group circuit arrangement typically located in a controller (a network element). The output of the loop circuit may then be branched to the downlinks of the data transmission group channels. The controller then manages the connections and disconnections of the group circuit arrangement including the loop circuit and the branches. Such a service is typically available in a limited geographical area, called a data conveyance group area in this application, or for a limited number of user terminals. Typically, data is broadcast in the radio interface.

The embodiment starts in block 200. In block 202, a data conveyance group is determined into a database used by the controller. Typically, the data conveyance group is determined by storing in the network database channel information on the channels group members are going to use. Therefore, in this embodiment, the data conveyance group is at least partially predetermined, typically in the network configuration phase. The data conveyance group area (typically referring to the cells wherein the group members are) can be automatically established when the base station system is put into use, or the data conveyance group area can be established by a specific message or command.

In block 204, downlink connections to data conveyance group members are activated. Typically, when a data conveyance group area is established, downlink connections are provided for all members belonging to it.

In block 206, a member of a data conveyance group having data to be conveyed is identified, and an uplink connection for data conveyance is activated.

The group member willing to transmit data may be identified or detected in many ways. One possibility is that the group member actively sends a message indicating willingness to transmit. Another option is to use an automatic procedure which may be based on speech detection, for example. Also a prior art uplink allocation procedure, which will be explained later in this application, may be used.

The downlink and uplink connections may be implemented by using a group circuit arrangement including the loop circuit and the branches to the receiving members as described above. One example of the group circuit arrangement is depicted in FIG. 4. In this example, the group circuit arrangement is placed in a base station controller. A group member transmitting data uses circuit 418. Circuits 414, 416 and also 418 are used for conveying data to other group members. In this example, data conveyance is performed in a half-duplex mode, but it is obvious to a person skilled in the art that another mode is also possible.

Arrows 400, 402 illustrate how the transmission is coupled by a loop circuit as an uplink input to the group circuit arrangement in a controller. The group circuit arrangement is typically implemented using one or more switches controlled by software.

The output of the group circuit arrangement may then be branched to the downlinks of channels used by the data transmission group. Arrows 404, 406, 408 depict downlink branch connections for conveying data to the receiving group members. Arrow 408, in particular, depicts how data is conveyed to other group members listening to the same channel. A transmitting user terminal may be arranged to attenuate speech on its downlink, this preventing an annoying echo.

Arrow 410 illustrates how an external subscriber may also be coupled to the data conveyance group. Arrow 412 depicts an A-interface circuit for an external user. This external user may include other members of the data conveyance group, such as other group channels, a talker on a dedicated channel or a dispatcher. These other members can be joined to this predetermined group call area via an MSC conference bridge.

In block 208, the data of the member of the data conveyance group is conveyed to other members by using the uplink and downlink connections. The connection may be implemented as the group circuit arrangement described above.

In block 210, the uplink connection is deactivated after data conveyance. Deactivation is usually performed by disconnecting the uplink connection in the required switches. The switches are usually controlled by software, in which case the connecting/disconnecting procedure is controlled by messages or commands. The procedure may be automatic, being based for example on speech detection, or it can be launched by the transmitting group member. Several alternatives exist for implementation.

In block 212, the downlink connections are deactivated. This means that the data conveyance group is also deactivated. Deactivation is usually performed by disconnecting the downlink connections in the required switches.

The embodiment ends in block 214. The embodiment may be repeated when the group member transmitting data changes. Also the number of group members and/or the group members can be changed between data conveyance sessions, such as calls.

In conference calls or in other kind of group calls, a dispatcher-function is sometimes needed. In one embodiment of the data transmission method described above, a dispatcher-function may be implemented by introducing a special access code. After a BSC has received this access code, it disconnects other speakers from the connections used for a group call.

Prior art VGCS call procedures are explained in 3GPP 48.008, 48.058 and 43.068 specifications.

In prior art VGCS, a group call register (GCR) is also used. A GCR function is mainly a database function, storing information about voice group calls. In a parallel use of the prior art VGCS and an embodiment of the data transmission method, the GCR may contain information on pre-configured data conveyance group areas defined in a radio network data-base of a base station controller (BSC).

In a prior art voice group call service and voice broadcast service (VGCS/VBS) when a VGCS/VBS call is set up, the MSC initiates a VGCS/VBS set-up procedure to a base station sub-system (BSS). The MSC sends a BSS a VGCS/VBS SETUP message across a VGCS/VBS call controlling signalling connection control part (SCCP) connection. This connection is established for the lifetime of the VGCS/VBS call. The BSS allocates resources to the call and returns a VGCS/VBS SETUP ACK message to the MSC. Next the MSC may allocate VGCS channel resources to the VGCS/VBS call by initiating a VGCS/VBS Assignment procedure.

If the prior art VGCS and an embodiment of the data transmission method described above are used parallel to each other, the MSC may launch the pre-configured data conveyance group area by sending a VGCS/VBS SETUP message to the BSC. Next the MSC may combine the pre-configured data conveyance group area to a prior art VGCS call by sending a VGCS/VBS ASSIGNMENT REQUEST message to the BSC where the predefined area is requested to be combined with the VGCS call.

IN the specifications, a prior art method for identifying a group member having data to be conveyed is called an uplink allocation procedure. After a user terminal has sent an UPLINK ACCESS message on a channel activated for a group call, a base station forms a VGCS UPLINK GRANT message and sends the message to the user terminal in unacknowledged mode on the main signalling link. A TALKER DETECTION message is sent to the base station controller.

In this embodiment, uplink reservation for a VGCS call for radio and A-bis interfaces can be carried out in the way described in 3GPP TS 48.0108 standard, chapter 3.3.1.24, and 3GPP TS 44.058 standard, chapter 4.13, the standards defining voice group call uplink access and talker detection procedures. Uplink allocation, uplink release and uplink seize procedures are carried out in an A-interface according to the standard 3GPP TS 48.008, chapter 3.1.24. However, when no MSC resources are allocated for a VGCS call, the BSC makes all decisions related to the uplink allocation without any negotiations with the MSC.

The MSC may connect an external user to the data conveyance group by connecting an A-interface circuit to the external user's circuit and then performing an A-interface assignment procedure where the A-interface circuit is connected to the data conveyance group.

Referring to FIG. 3, a simplified block diagram illustrates an example of a logical structure of a base station controller. A base station controller (BSC) is herein taken as an example of a controller. Another example of a controller could be a network element acting as a base station and as a base station controller simultaneously. Other implementations are also possible. Network elements taking care of network control are named differently in different systems. For example, a base station controller is called a radio network controller in a universal mobile telecommunications system, UMTS.

The BSC is in charge of radio interface management, mainly of the allocation and release of radio channels and handover management. Radio resource management is a group of algorithms used for sharing and managing a radio path connection so that the quality and capacity of the connection are adequate.

The functionality of the base station controller can be divided into two main classes: radio resource management 306 and control functions 310. The control functions take care of functions related to the set-up, maintenance and release of a radio connection between base stations and user terminals. In this embodiment, the database 316 needed for storing information on a data conveyance group is controlled by the control functions.

An operation and management interface function 308 serves as a medium for information transfer to and from network management functions.

Switching 300 takes care of connections between a core network and a user terminal. A base station controller is located between A-bis 302 and A 314 interfaces. The base station controller is connected to these interfaces via interface units 304, 312.

The precise implementation of the base station controller is vendor-dependent.

In one embodiment of the data transmission method, a data conveyance group is determined into a database used by the controller. The database typically locates in a BSC.

Data (for instance speech) of the transmitting group member is conveyed to other members of the data conveyance group by using a connection activated or established for this data transmission. The connection may be implemented as a group circuit arrangement described above.

In this example, the embodiments of the data transmission method described above, are, mainly carried out in switching 300 and control functions 310 of the base station controller.

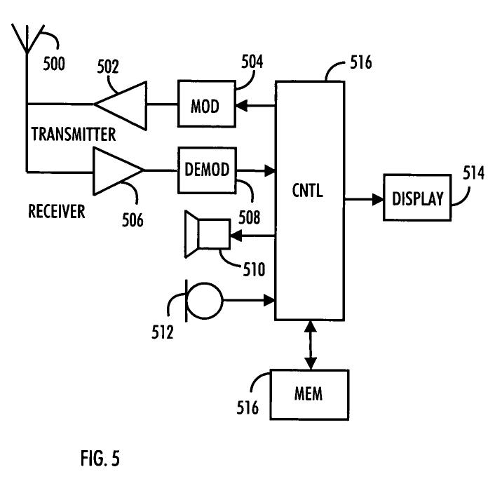

FIG. 5 shows a simplified example of a user terminal whereto the embodiment of the invention can be applied. The user terminal is herein taken as an example of a communication terminal. The terminal may be a mobile telephone or a microcomputer, for example, without being restricted thereto.

The terminal comprises an antenna 500 with which signals are both transmitted and received via a duplex filter.

The terminal further comprises a transmitter 502 to amplify and transmit a modulated signal to the antenna, a modulator 504 modulating the carrier wave by a data signal comprising the desired information in accordance with a selected modulation method, a receiver 506 which amplifies the signal supplied from the antenna and down-converts the signal to a selected intermediate frequency or directly to base band, and a demodulator 508 demodulating the received signal to enable a data signal to be separated from the carrier wave.

The user terminal also comprises a control block 516 comprising, for example, control and calculation means for controlling the operation of different parts of the terminal, means for processing speech of a user or data generated by the user, such as a digital signal processing (DSP) processor comprising, for example, channel correction functions compensating for interference in the signal caused by the radio channel by utilising information on the channel obtained from a known training sequence, A/D converters converting an analogue signal into a digital one by sampling and quantizing the base band signal, D/A converters converting a digital signal to an analogue one by a reverse method, filters at the receiver which filter frequencies outside a desired frequency band or, which in band-restricted systems restrict the band width of the output at the transmitter, and coding and decoding means for both channel and speech coding.

In one embodiment, control block 516 communicates with a base station or a base station controller to perform data conveyance between group members, such as a group call. The control block for example generates transmissions (messages or commands) for launching connection or disconnection of switches in BSC. The transmission typically includes identification information on a group member willing to convey data.

Furthermore, in spread-spectrum systems, such as WCDMA, the spectrum of the signal is spread at the transmitter by means of a pseudorandom spreading code over a wide band and despread at the receiver, in an attempt to increase channel capacity.

The control block also comprises means for arranging the signal to be transmitted and signalling information to conform with the air interface standard of the system used.

The user interface of the terminal comprises a loudspeaker or an earpiece 510, a microphone 512, a display 514 and possibly a keypad and/or a joystick or a similar device. The user interface devices communicate with the control block. In FIG. 5, a memory block 516, is also depicted.

Even though the invention has been described above with reference to an example according to the accompanying drawings, it is clear that the invention is not restricted thereto but it can be modified in several ways within the scope of the appended claims.

1. A data transmission method in a communication system, the communication system comprising at least one controller, the method comprising:
determining a data conveyance group stored in a database used by the at least one controller; and
conveying data between data conveyance group members by using a group circuit arrangement including a loop circuit for transferring data from a transmitting group member and branches to receiving members.

2. A data transmission method in a communication system, the communication system comprising at least one controller, the method comprising:
determining a data conveyance group stored in a database used by the at least one controller;
activating downlink connections to data conveyance group members;
identifying a data conveyance group member having data to be conveyed and activating an uplink connection for data conveyance;
conveying the data of the data conveyance group member to other members of the data conveyance group by using the uplink and downlink connections;
first deactivating the uplink connection after data conveyance; and
second deactivating the downlink connections.

3. A data transmission method in a communication system, the communication system comprising at least one controller, the method comprising:
specifying a data conveyance group stored in a database used by the at lease one controller;
detecting a group member having data to be transmitted and establishing connections for conveying the data;
conveying the data of the group member to other members of the data conveyance group by using the connections; and
disbanding the connections after data conveyance.

4. The method of claim 2, wherein the data conveyance group is at least partially predetermined.

5. The method of claim 2, further comprising sending a message by a group member for identifying a group member who has data to be conveyed.

6. The method of claim 2, wherein the connection means is a group circuit arrangement including a loop circuit for transferring data from a transmitting group member and branches to the receiving members.

7. The method of claim 2, wherein the connection means is a group circuit arrangement including a loop circuit for transferring data from a transmitting group member and branches to the receiving members, wherein activating or deactivating the connection means is carried out by using a switch for connecting and disconnecting selected parts of a group circuit arrangement.

8. The method of claim 2, further comprising a dispatcher-function implemented by introducing a special access code.

9. The method of claim 2, wherein data is conveyed in a half-duplex mode.

10. A controller of a communication system, comprising:
storing means for storing information on a data conveyance group; and
conveying means for conveying data between group members by using a group circuit arrangement including a loop circuit for transferring data from a transmitting group member and branches to receiving members.

11. A controller of a communication system, comprising:
storing means for storing information on a data conveyance group;
uplink and downlink connection means for data conveyance;
activating means for activating the downlink connection means to data conveyance group members;
identifying means for identifying a data conveyance group member having data to be conveyed;
activating means for activating the uplink connection means for data conveyance;
deactivating means for deactivating the uplink connection means; and
deactivating means for deactivating the downlink connection means.

12. A controller of a communication system, comprising:
storage means for storing information on a data conveyance group;
connection means for conveying data;
detection means for detecting a data conveyance group member having data to be transmitted;
activating means for activating the connection means; and
disbanding means for disbanding the connection means.

13. The controller of claim 11, further comprising transmitting means for sending a message by a group member for identifying a group member who has data to be conveyed.

14. The controller of claim 11, wherein the connection means is a group circuit arrangement including a loop circuit for transferring data from a transmitting group member and branches to the receiving members.

15. The controller of claim 11, wherein the connection means is a group circuit arrangement including a loop circuit for transferring data from a transmitting group member and branches to the receiving members, wherein activating or deactivating the connection means is carried out by using a switch for connecting and disconnecting selected parts of a group circuit arrangement.

16. A controller of a communication system, configured to:
store information on a data conveyance group;
activate downlink connection means to data conveyance group members;
identify a data conveyance group member having data to be conveyed;
activate uplink connection means;
convey the data of the data conveyance group member to other members by using the uplink and downlink connection means; and
deactivate the uplink connection means and the downlink connection means.

17. A communication terminal, comprising:
means for generating at least one transmission for controlling group data conveyance, the at least one transmission being transmitted to a controller of a communication system for processing.

18. The communication terminal of claim 17, further comprising means for including, into the at least one transmission, identification information on a group member willing to convey data.

19. The communication terminal of claim 17, further comprising means for generating transmissions for launching the connection or disconnection of switches located in a controller controlling a network of a user terminal.

20. A communication terminal, configured to:
generate at least one transmission for controlling group data conveyance, the at least one transmission being conveyed to a controller of a communication system for processing.
